(19) United States
(12) Patent Application Publication
(10) Pub. No.: US 2020/0153354 A1
(43) Pub. Date: May 14, 2020

(54) CONTROLLING VOLTAGE IN AC POWER LINES

(71) Applicant: Vollspark Ltd., Tel Aviv (IL)

(72) Inventors: Shaul Ozeri, Tel Aviv (IL); Tal Tayar, Tel Aviv (IL); Liran Katzir, Tel Aviv (IL)

(21) Appl. No.: 16/683,284

(22) Filed: Nov. 14, 2019

Related U.S. Application Data
(60) Provisional application No. 62/760,938, filed on Nov. 14, 2018.

(51) Int. Cl. H02M 5/293; H01F 27/24; H01F 27/38; H02J 7/02; H01F 3/14; H02J 3/00

(52) U.S. Cl. CPC H02M 5/293; H01F 27/24; H01F 27/38; H02M 1/08; H01F 3/14; H02J 3/00; H02J 7/022

(57) ABSTRACT

Regulating an AC voltage. The device includes a magnetic core, multiple windings around the core, and multiple switch arrays connectable between an AC power source and respective windings. The switch arrays including multiple switches controllable to connect the AC power source to the windings in a first polarity or in a second polarity. The first polarity and second polarity are different polarities, e.g. phase shifted by 180 degrees. An electrical conductor is disposed around or through the core. The electrical conductor is series-connectable to a power line. AC voltage of the power line is regulated by adding an AC voltage of the electrical conductor responsive to selection of the switches of the switch arrays.

### BACKGROUND

### 1. Technical Field

The present disclosure relates to alternating current (AC) voltage stabilization such as for power generation and charging of batteries.

### 2. Description of Related Art

Long distribution lines, may cause the AC voltage supplied to customers to deviate from nominal voltage. In recent years, there has been an increasing penetration of distributed and renewable energy sources such as solar panels and wind turbines to the electrical power grid. These energy sources may cause local voltage instabilities in the electrical power grid as they contribute power in various locations of the grid without central control. Therefore, electrical utilities are searching for ways to control AC voltage at various nodes and along distribution lines.

Thus, there is a need for and it would be advantageous to have an improved system/method for controlling the electrical distribution grid.

### BRIEF SUMMARY

Various methods and devices are disclosed herein for regulating an AC voltage. The device includes a magnetic core, multiple windings around (or through) the core, and multiple switch arrays connectable between an AC power source and respective windings. The switch arrays including multiple switches controllable to connect the AC power source to the windings in a first polarity or in a second polarity. The first polarity and second polarity are different polarities, e.g. phase shifted by 180 degrees. An electrical conductor is disposed through the core. The electrical conductor is series-connectable to a power line. AC voltage of the power line is regulated by adding an AC voltage of the electrical conductor responsive to selection of the switches of the switch arrays. One or more switch arrays may be further controlled to (i) disconnect an AC power source from a respective winding, (ii) disconnect an AC power source from and short circuit the respective winding, or (iii) add zero voltage to the electrical conductor. The magnetic core, the windings, and the electrical conductor may comprise a transformer. The windings may include a plurality i of primary windings, where i may be a plural integer. The iₜₕ winding may include Nᵢ turns. Nᵢ are positive integers. The electrical conductor may be a secondary of one turn. Primary to secondary turns ratio of the transformer may equal Nᵢ respectively for the primary windings. During operation, a primary AC voltage VACᵢ may be applied to the i primary windings. The AC voltage of the electrical conductor may be incremented by plus or minus primary AC voltage VACᵢ divided by the turns ratio Nᵢ, (±VACi/Nᵢ) or zero depending on the selection of the switches of the switch arrays. The magnetic core may include multiple magnetic cores and the electrical conductor may be inserted through the magnetic cores. The electrical conductor may be a single electrical conductor inserted through the magnetic core. The magnetic core may include a gap. and during operation, peak magnetic flux through the core may be lower than a saturation level of the magnetic core. During operation, primary AC voltage VACᵢ applied to the windings may be sensed by a sensor in order to switch between operational switching states of the switches, at a switching time tₛ when primary AC voltage VACᵢ is within a previously determined time interval of a maximum positive or negative peak voltage. The device may further include a controller, and a sensor connectable to the controller. During switching, the controller may be configured to sense the primary AC voltage VACᵢ and AC input frequency, and to match a first attenuation peak of a digital finite input response filter (FIR) to correspond with the AC input frequency. The device may further include a controller, a magnetic flux sensor connectable to the controller, and an auxiliary winding around or through the core. The controller is configured to sense magnetic flux using the magnetic flux sensor and to drive the auxiliary winding with a compensation current having a level and polarity that reduces below a previously determined threshold a flux transient in the core. The device may be configured to regulate grid voltage in a mains power line, or to feed a direct current (DC) regulating circuit thereby regulating DC voltage from an AC power line, for charging batteries, by way of example.

Various methods are disclosed herein for regulating AC voltage using a device including: a magnetic core, multiple windings around (or through) the core and multiple switch arrays connectable between an AC power source and the respective windings. The switch arrays each include multiple switches. An electrical conductor is disposed around or through the core. During operation the switches are controlled connect the AC power source to the windings in a first polarity or in a second polarity. The first polarity and second polarity are different polarities. The electrical conductor is series connectable to a power line to regulate an AC voltage of the power line by adding an AC voltage of the electrical conductor responsive to the control of the switches. During operation, one or more of the switch arrays may be further controlled to (i) disconnect an AC power source from a respective winding, (ii) disconnect an AC power source from and short circuit the respective winding, or (iii) add zero voltage to the electrical conductor. The device may be configured to regulate grid voltage in a mains power line, or to feed a direct current (DC) regulating circuit thereby regulating DC voltage from an AC power line for charging batteries, by way of example.

### BRIEF DESCRIPTION OF THE DRAWINGS

The invention is herein described, by way of example only, with reference to the accompanying drawings, wherein:

FIG. 1 is a simplified electronic schematic drawing illustrating an alternating current (AC) cell, according to features of the present invention;

FIG. 2 illustrates a graph of primary magnetization current during polarity switching, according to a feature of the present invention;

FIG. 3 illustrates respective graphs, according to a feature of the present invention, of voltage input Vᵢₙ and core flux Φ during switching at a switching time t_{S} when input AC voltage is or close to a maximum positive or negative peak voltages;

FIG. 4 illustrates schematically a magnetization current Iₘ peak before and after active compensation;

FIG. 5 illustrates a graph, according to a feature of the present invention, of the frequency response of digital finite input response filter (FIR);

FIG. 6 is a simplified electronic schematic drawing which illustrates an AC cell, according to an embodiment of the present invention, in a push-pull configuration with a tapped primary connection;

FIG. 7 illustrates a core type transformer with a gap in a center leg, according to a feature of the present invention;

FIG. 8 illustrates a core type transformer according to another feature of the present invention, with a gap in an outer leg;

FIG. 9 illustrates a graph showing a drop in secondary inductance as a function of secondary current, according to a feature of the present invention;

FIG. 10 illustrates an AC string constructed by connecting AC outputs of multiple AC cells in a series configuration, according to features of the present invention;

FIG. 11 illustrates a feature according to the present invention including an AC string connected in series to the secondary of a power transformer;

FIG. 12 illustrates a feature, according to the present invention, in which a string of AC cells generate a grid voltage e.g. 230 Volts root mean squared.

FIG. 13 illustrates a feature, according to the present invention, with AC cells series-connected at outputs implemented with a common conductor through multiple AC cell cores;

FIG. 13A shows an external view of the embodiment of the present invention as shown in FIG. 13;

FIG. 13B shows an external view of device according to features of the present invention implementing multiple windings through/around a single core and with outputs series-connected implemented with a common conductor;

FIG. 14 illustrates a controlled 3-phase delta AC voltage source using AC cell strings, according to features of the present invention;

FIG. 15 illustrates a 3-phase Wye voltage source using AC cell strings to produce a 3-phase Wye voltage source, according to a feature of the present invention;

FIG. 16 illustrates a Wye 3-phase system, with three AC cell strings connected in series with respective taps of a Wye transformer, according to features of the present invention;

FIG. 17 illustrates a schematic diagram of a regulated AC: DC system employing three phase power transformer, and three AC cell strings, with a controlled output DC voltage, according to a feature of the present invention;

FIG. 18 illustrates an AC: DC system including a three-phase hybrid power transformer, according to a feature of the present invention; and

FIG. 19 is a flow diagram illustrating a method, according to a feature of the present invention.

The foregoing and/or other aspects will become apparent from the following detailed description when considered in conjunction with the accompanying drawing figures.

### DETAILED DESCRIPTION

Reference will now be made in detail to features of the present invention, examples of which are illustrated in the accompanying drawings, wherein like reference numerals refer to like elements throughout. The features are described below to explain the present invention by referring to the figures.

By way of introduction, various devices are disclosed herein which may be attached to the secondary of a power transformer in the grid or a mains power line in order to stabilize the grid voltage in the mains power line. Electrically, the device may include a series-connection of transformer secondaries. The respective transformer primaries are connected to one or more AC power sources by respective arrays of switches. The switches may control the polarity of the voltage contribution in the transformer secondaries or disconnect the primary. Mechanically, the series-connection of transformer secondaries may be implemented as a single electrical conductor, e.g. a copper rod, so that high current connections between the transformer secondaries are avoided. Alternatively, the device may be used to generate direct current (DC) from an AC power source (from grid or AC power source other than the grid) for charging a battery.

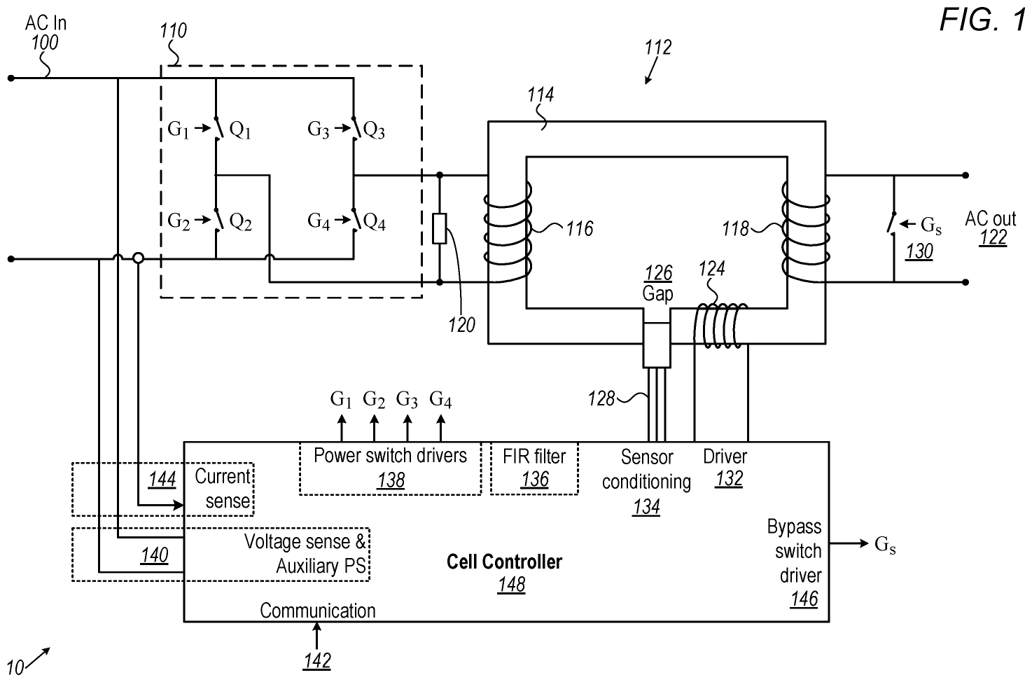

Referring now to the drawings, reference is now made to FIG. 1 which illustrates an alternating current (AC) cell 10, according to features of the present invention. Alternating current (AC) input terminals 100 connect through a bidirectional switch array 110 to input windings 116 of transformer or coupled inductors 112. An AC voltage may be coupled through a magnetic core 114 to output windings 118 and to AC output terminals 122 of transformer 112. Bidirectional switch array 110 is shown with four power switches Q1, Q2, Q3 and Q4 which may be switched to reverse polarity of the input AC voltage or to switch off AC input voltage at input terminals 100. Bidirectional switch array 110 may be configured using two metal-oxide semiconductor field-effect (MOSFET) transistors or two insulated-gate bipolar transistors (IGBT) in a series connection. A cell controller 148 includes power switch drivers 138 with outputs G1, G2, G3 and G4 for controlling switches, Q1, Q2, Q3 and Q4 respectively. Power switches Q1, Q2, Q3 and Q4 accept control commands G1, G2, G3 and G4 from power switch drivers 138. Controller 148 may command power switches Q1, Q2, Q3 and Q4 to deploy working states on primary winding 116 including: (i) connecting primary 116 to an AC input source in a first polarity (ii) connecting primary 116 in a second polarity which may be 180 degrees shifted from the first polarity, (iii) disconnecting primary 116 from an AC power source, e.g. grid, and (iv) disconnecting primary 116 from an AC power source and imposing a short circuit on primary 116.

When controller 148 commands power switches Q1, Q2, Q3 and Q4 to switch the transformer primary between these working states, a transient phenomenon may occur that may drive magnetic core 114 into saturation. Various features of the present invention are directed to avoid magnetic saturation during switching between the operational states. When cell controller 148 changes polarity of AC source voltage to input windings 116 windings of transformer 112, a transient increase of magnetic flux in core 114 may occur. The transient flux may have positive or negative polarity. The flux transient may saturate core 114 and consequently cause excessive current flow from the source through the bidirectional power switch array 110.

Transformer 112 may be designed to reduce saturation, by configuring core with a gap 126. Transformer 112 configured with gap 126 may be designed such that at steady state working conditions, peak magnetic flux is significantly lower than the core saturation level, so even during a switching transient, flux is maintained below magnetic saturation level.

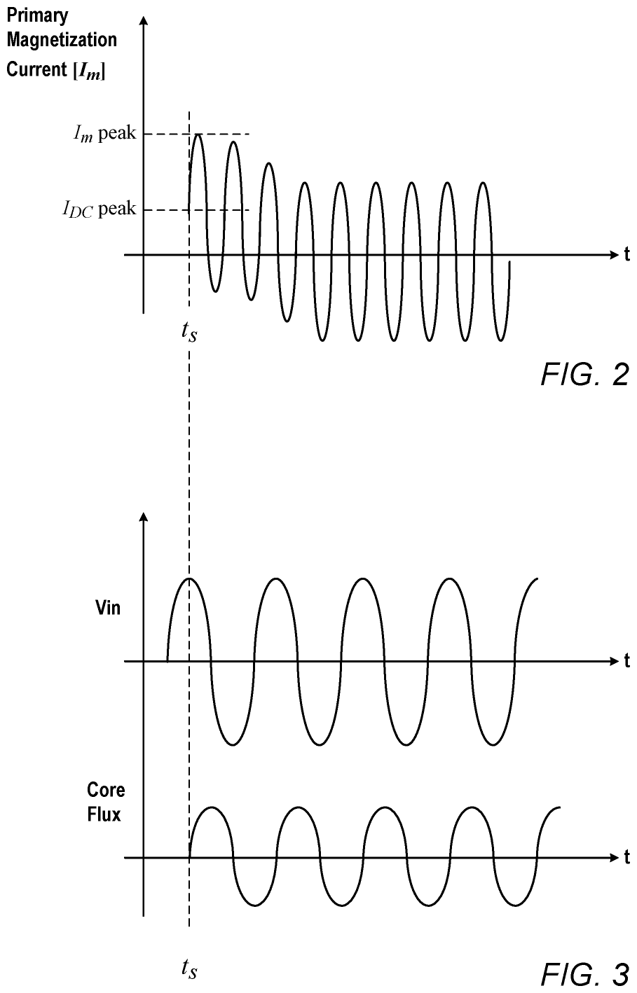

Alternatively, controller 148 may be configured to sense the AC input voltage using voltage sense 140 connections to AC input 100 connections, and switch between operational switching states of switch array 110 at a switching time t_{S} when input AC voltage is or close to a maximum positive or negative peak voltages. Reference is now also made to FIG. 2 which illustrates a graph of primary magnetization current during polarity switching of transformer primary 116, according to a feature of the present invention. Direct current (DC) transient I_{DC} and Iₘ peak currents are shown during a time transient at switching time tₛ. Reference is made also to FIG. 3 which schematically illustrates graphs of voltage input Vᵢₙ and core flux Φ during switching of switch array 110 at a switching time t_{S} when input AC voltage is or close to a maximum positive or negative peak voltages. Absolute value of core flux Φ is close to zero when switching time tₛ is close to a peak voltage Vᵢₙ

Referring back to FIG. 1, a magnetic flux sensor such as a Hall effect sensor 128 may be connected to sensor conditioning circuit 134, part of cell controller 148, to sense magnetic core 114 flux. Hall effect sensor 128 is shown disposed within air gap 126. An auxiliary winding 124 may be incorporated wound around core 114. When bidirectional switch array 110 switches between operational states, cell controller 148 may provide active compensation and sense magnetic flux using magnetic flux sensor 128, and accordingly drive auxiliary winding 124 through a current driver 132 with a compensation current I_{c} having a level and polarity that minimizes flux transient in core 114.

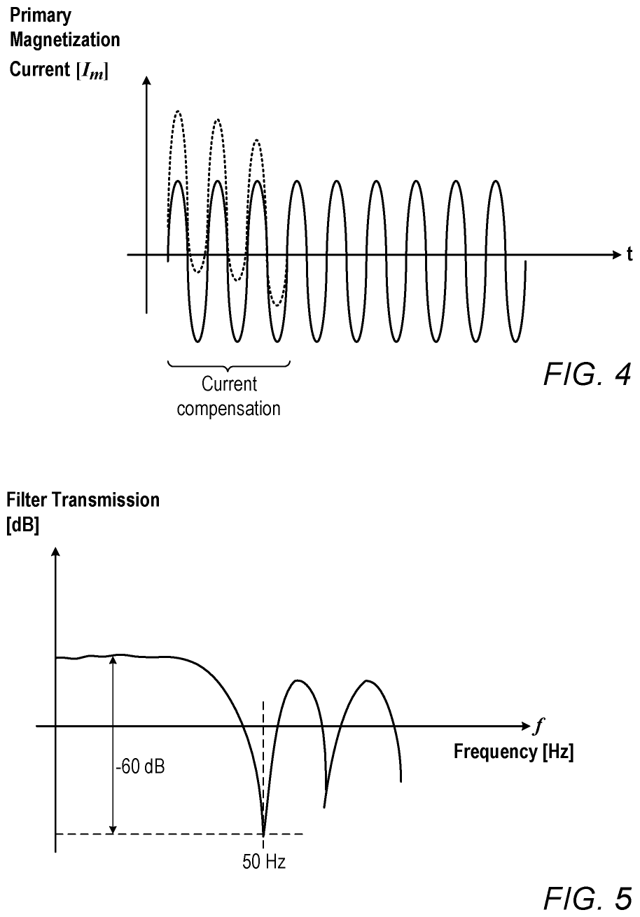

Reference is now also made to FIG. 4 which illustrates schematically magnetization current Iₘ peak before (dotted line) and after (continuous line) active compensation. In order to rapidly respond and compensate the transitory flux, cell controller 148 may be configured to distinguish between the switching transient and AC low frequency, e.g. 50 Hertz flux variation. Since using a low pass filter to extract the flux transitory phenomena may be too slow in terms of phase delay, controller 148 may incorporate a digital finite input response filter (FIR) 136.

Reference is now also made to FIG. 5 which illustrates, according to a feature of the present invention, a graph of the frequency response of digital finite input response filter (FIR) 136. The input AC frequency, e.g. 50 Hertz is coherently located in a valley of the ripple at the stop band. Controller 148 may sense input AC voltage and may frequency match FIR filter 136 to the AC input frequency in such a way that a first attenuation peak of the FIR frequency response corresponds with the AC input frequency, e.g. 50 Hertz. Although low order FIR filter 136 may have less than −20 decibel over a broad stop band, high attenuation, e.g. −60 decibel at the sensed AC frequency may be achieved in a narrow frequency band.

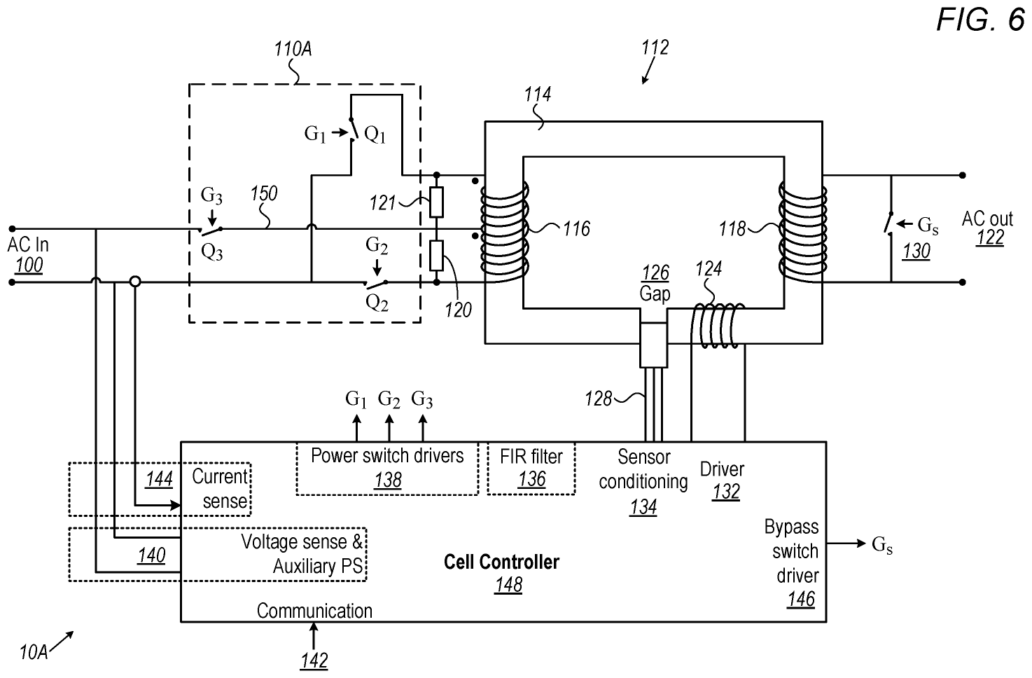

Reference is now made to FIG. 6 which illustrates an AC cell 10A in an alternative configuration to AC cell 10 (FIG. 1) with a tapped primary connection 150. Switch Q3 connects tapped primary connection 150 to one of AC input connections 100. The other AC connection 100 is switched alternatively to input windings 116 using alternatively switch Q1 and switch Q2. In bidirectional switch configuration 110A, when Q3 and Q1 are closed, AC output 122 of cell 10A is at a first polarity. When switches Q3 and Q2 are closed, AC output 122 of transformer 112 is at an opposite polarity relative to the first polarity. If Q3 is disconnected and Q1 and Q2 are connected, AC output 122 is short circuited. If Q1, Q2 and Q3 are all disconnected, cell AC output 122 may behave as an inductor.

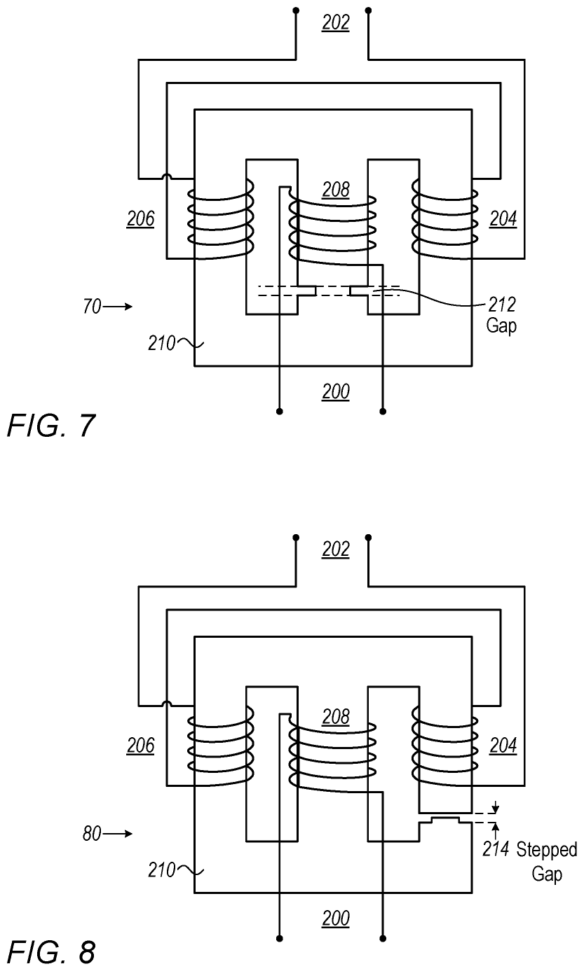

Reference is now made to FIG. 7 which illustrates a core type transformer 70, according to features of the present invention. Transformer 70 includes a magnetic core 210 with three legs. Primary coil 208 is wound around the central leg with primary terminals 200. Secondary coil 204, 206 having secondary terminals 202 is shared and wound around the outer legs. Transformer 70 may incorporate an air gap 212 in the central core leg. Air gap 212 may have various shapes: uniform, ramp or stepped. Stepped air gap may introduce a lower magnetizing current during normal operation, and therefore reduce the power loss of the transformer. During switching intervals, the effective gap may be larger and consequently maintain magnetic flux below saturation level.

Reference is now made to FIG. 8 which illustrates a core type transformer 80 according to features of the present invention. Transformer 80 includes a magnetic core 210 with three legs. Primary coil 208 is wound around the central leg with primary terminals 200. Secondary coil 204, 206 having secondary terminals 202, is shared and wound around the outer legs. Transformer 80 may incorporate a stepped air gap 214 in an outer core leg. Transformer 80 may have a left magnetic loop that has comparatively low magnetic reluctance, and a right magnetic loop that has higher magnetic reluctance due to the presence of air gap 214 in the loop. During steady state, the left magnetic loop carries most of the magnetic flux. During transients caused by switching of the inputs of transformer 80, the left magnetic path may saturate and magnetic flux may be directed to the right magnetic loop that includes air gap 214 and consequently avoid magnetic saturation of the overall core 210.

Reference is now made again to FIGS. 1 and 6, which illustrate respectively AC cells 10 and 10A respectively, according to further features of the present invention. Current sense 144 of AC input 100 may sense current over a previously defined current specification. Switch array 110, 110A may be used to disconnect AC cell 10,10A from AC input 100. A bypass switch 130 may short output 122 of AC cell 10,10A in case cell 10, 10A output is above a previously defined current specification. Components 120, 121 at the inputs of primary winding 116 may be over-voltage protection circuits, e.g. bidirectional Zener diodes. A communications port 142 may be used for local and/or remote monitoring and control of AC cells 10, 10A.

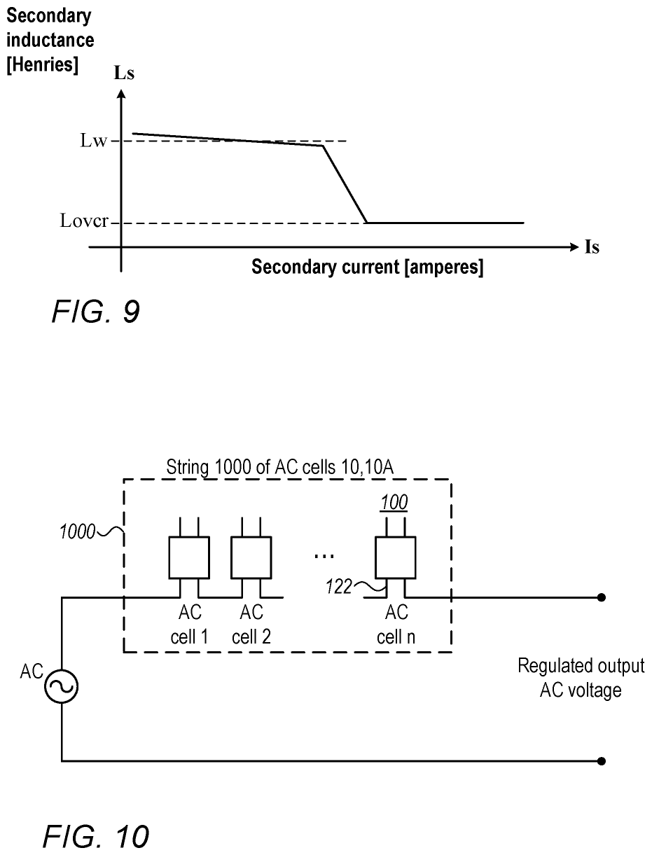

Reference is now made to FIG. 9, which illustrates a graph of secondary inductance as a function of secondary current, according to a feature of the present invention. In order to protect AC Cell 10, 10A and not reflect excessive current to input terminals 100 through bidirectional power switch array 110, 110A, AC cell 10, 10A may be configured to saturate output inductance Lₛ of cell transformer 112 in case of over current. The inductance of the secondary Lₛ may drop from its normal working value L_{w} to a much lower inductance value Lₒᵥₑᵣ.

### AC Cells 10, 10A in Serial Strings

AC cell 10, 10A as shown in FIGS. 1 and 6 respectively may be used as a building block for the construction of power systems intended for various applications such as regulating the AC output of distribution power lines in the electrical grid, or regulating an AC voltage feeding a DC regulating circuit for charging batteries.

Reference is now made to FIG. 10 which illustrates an AC string 1000 with series-connections AC outputs 122 of respective AC cells 10, 10A in a series configuration, according to features of the present invention. AC string 1000 voltage may be configured to be much lower than nominal AC grid voltage. AC string 1000 connected in series to a power line in grid enables regulation of the AC voltage of the power line. Since AC output 122 of each cell 10, 10A may be controlled by a positive incremental voltage, a negative incremental voltage or zero using bidirectional switch array 110, 110A, AC voltage of string 1000 may be regulated according to voltage requirements of the grid, by individually configuring AC cells 10, 10A as desired.

AC cell string 1000 including multiple series-connected AC Cells 10, 10A has several benefits:
AC cell string 1000 enables high regulation resolution of the string equivalent voltage.
AC cell string 1000 also enables distribution of heat caused by the power loss in AC cells 10, 10A.
AC string 1000 may incorporate redundant AC cells 10, 10A with more series-connected AC cells 1000 than are required to reach a desired voltage correction, to improve overall reliability. AC cells 10, 10A series connected in string 1000 may be switched on and off according to a random pattern, according to a predetermined pattern, in order to better distribute the heat caused by their losses between different AC cells or spread heat losses more evenly on a heat sink surface.

Output voltage of AC cells 10, 10A series-connected at outputs 122 into string 1000, may each supply the same voltage output. Alternatively, AC cells 10, 10A in string 1000 may be configured to output different output voltages. A basic example of a voltage pattern may be according to R-2R ladder network pattern, logarithmic voltage pattern etc.

A number n of AC cells 10, 10A may be series-connected with (n−1) AC cells 10, 10A each outputting the same voltage and one AC cell outputting half the voltage compared to the other (n−1) AC cells series connected in string 1000.

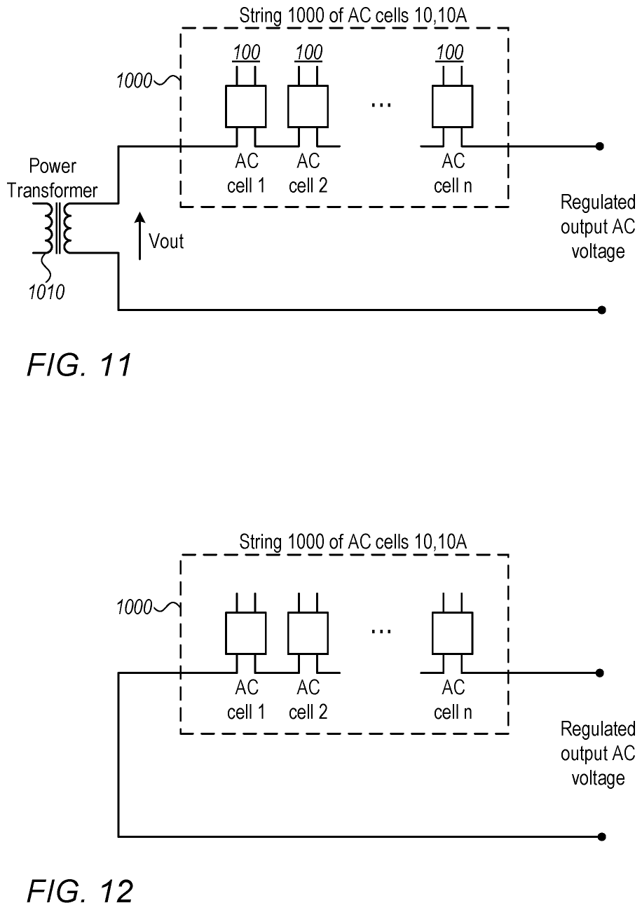

Reference is now made to FIG. 11, which illustrates a feature, according to the present invention. AC string 1000 may be connected in series to the output (secondary) of a common power transformer 1010. Inputs 100 of AC cells 10, 10A may be connected in parallel to the primary of power transformer 1010. Alternatively, inputs 100 of AC cells 10, 10A may be connected to one or more other power sources (not shown). Power transformer 1010 primary inputs may be connected to a low grid voltage, e.g. 230V RMS, but may also be connected to a high grid voltage such as 22 kiloVolt.

Reference is now made to FIG. 12, which illustrates a feature, according to the present invention. String 1000 may include sufficient AC cells 10,10A to generate a required AC voltage such as grid voltage e.g. 230 Volts root-mean square. In such a case, overall string 1000 AC voltage may be regulated.

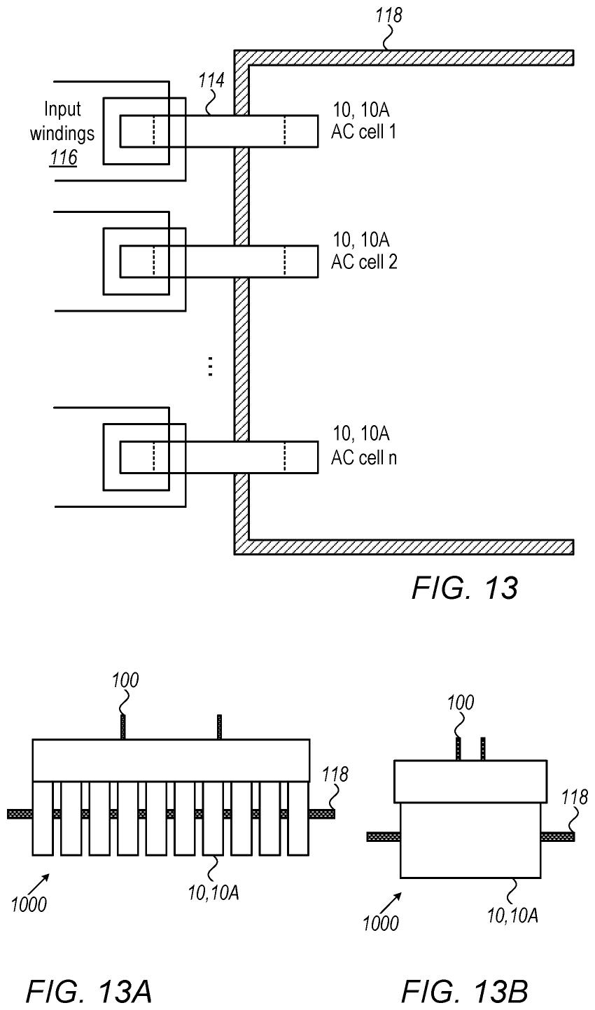

Reference is now also made to FIG. 13, which illustrates a feature, according to the present invention. AC cells 10, 10A series connected at outputs 122 may include transformer 112 with a secondary 118 of a single turn. Series connection of outputs 122 of multiple AC cells 10, 10A with respective secondaries 118 of a single turn may be implemented with a common electrical conductor 118 thread through or disposed within magnetic cores 114. Use of a common electrical conductor 118 to implement secondaries of transformers 112 eliminates a requirement to provide high current physical connections between secondaries 118 of multiple series-connected AC cells 10, 10A when secondaries are of multiple turns.

Reference is now also made to FIG. 13A, which shows an external view of AC string 1000 of AC cells 10, 10A sharing a common electrical conductor 118 for instance, a single conductor, e.g copper bar, rod or hollow pipe which implements the series connection at outputs 122. Reference is now also made to FIG. 13B which illustrates an external view of device 1000 including multiple primaries and multiple secondaries (not shown). In both FIG. 13A and FIG. 13B, input connections 100 to primaries may be in common, e.g. parallel as shown or individual input connections to primary connections 100 of AC cells 10, 10A may be configured (not shown).

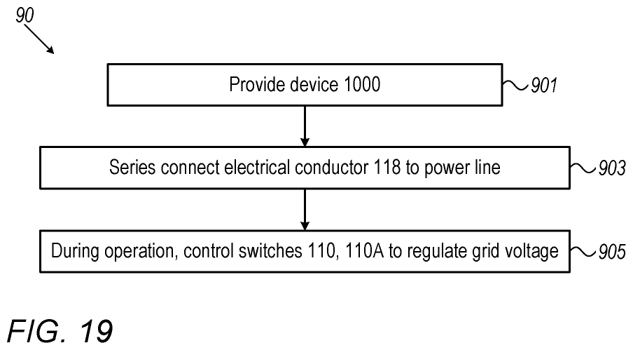

Reference is now made to FIG. 19, which illustrates an installation and operation method 90, according to features of the present invention. A device 1000 (such as shown in FIG. 13A or 13B) may be provided (step 901) and electrical conductor 118 is series connected to a power line. Switch arrays 110, 110A are connected (step 903) to AC power sources using input terminals 100, optionally in parallel to the power line being regulated, but another power source or multiple power sources may be used. During operation, control of switches (step 905) regulates the grid voltage in the power line.

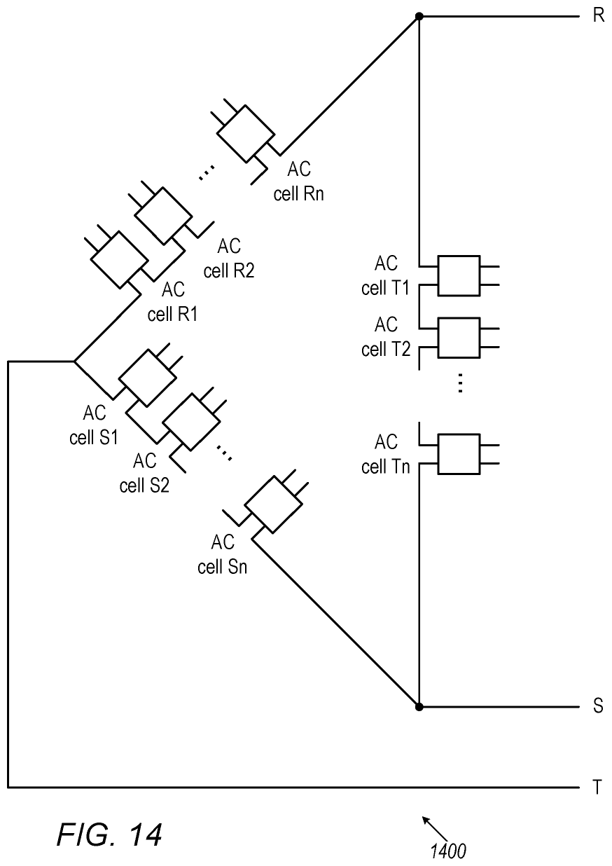

Reference is now made to FIG. 14 which illustrates a controlled 3-phase delta AC voltage source 1400 using AC strings 1000 respectively of AC cells 10,10A Rₗ through Rₙ, AC cells 10,10A S₁ through Sₙ, AC cells 10,10A Tₗ through Tₙ, according to features of the present invention.

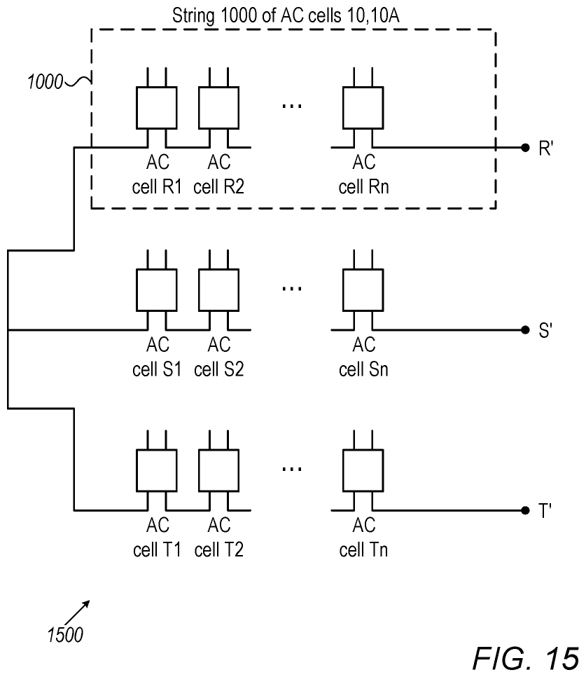

Reference is also made to FIG. 15 which illustrates a 3-phase Wye voltage source 1500 using AC strings 1000, according to features of the present invention. Three-phase voltage sources 1400 and 1500 may be configured with sufficient AC cells 10, 10A to generate three phase grid voltage.

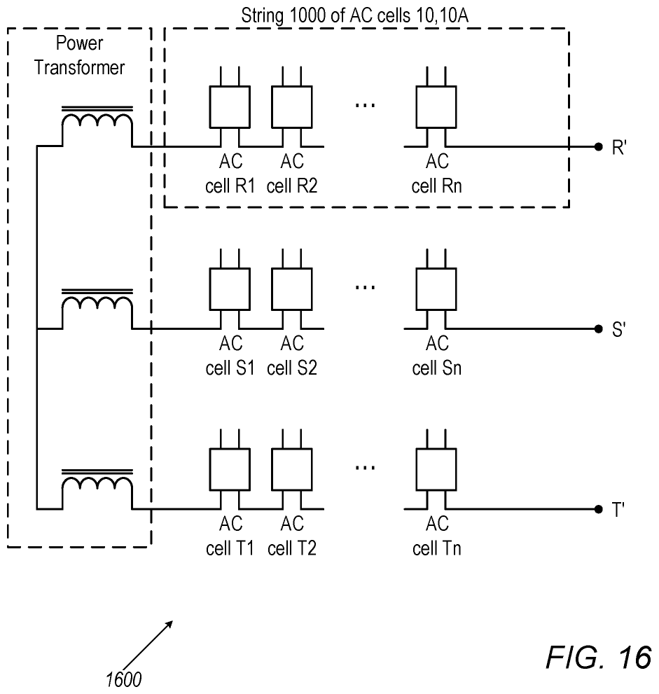

Reference is now also made to FIG. 16 which illustrates a 3-phase Wye system 1600. Three phase AC cell strings 1000 may be connected in series with transformer secondary or primary taps.

Alternatively, a delta configuration may be used. System 1600 may incorporate a 3-phase transformer with secondary taps connected in series with the AC cell strings 1000.

### Battery Charging

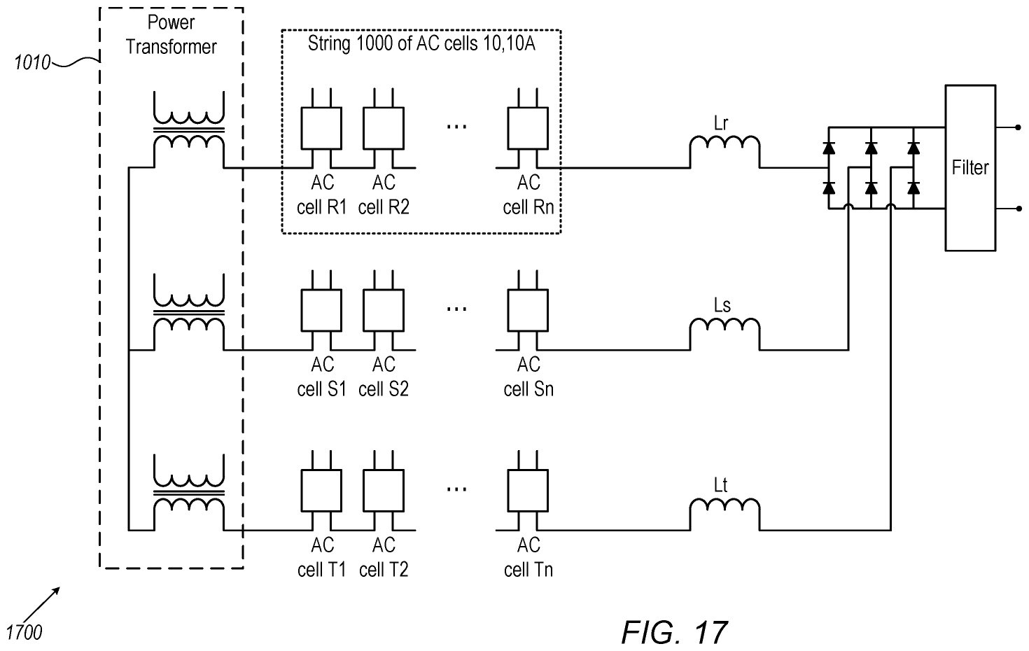

Reference is now also made to FIG. 17 which shows a battery charging system 1700 with controlled output DC voltage, according to a feature of the present invention. AC cell string 1000 may be used to construct a 3-phase battery charger unit either in Wye or delta configurations. System 1700 may incorporate a controller (not shown), and a power transformer 1010 that supplies output voltage, while AC voltage output from AC cell string 1000 is fed an input to a DC regulation circuit including inductors Lᵣ, L_{S} and Lₜ, a common rectifier circuit and a filter. Alternatively, a similar system may use three single-phase power transformers with each single-phase transformer output connected in series with one of AC cell strings 1000. System 1700 may incorporate a 3-phase transformer with secondary taps connected in series with AC cell strings 1000. The overall series connections may be connected in a Wye configuration as shown in system 1600 or connected in a delta configuration. DC output voltage of the battery charging system 1700, may be regulated by switching switch arrays 110 and 110A.

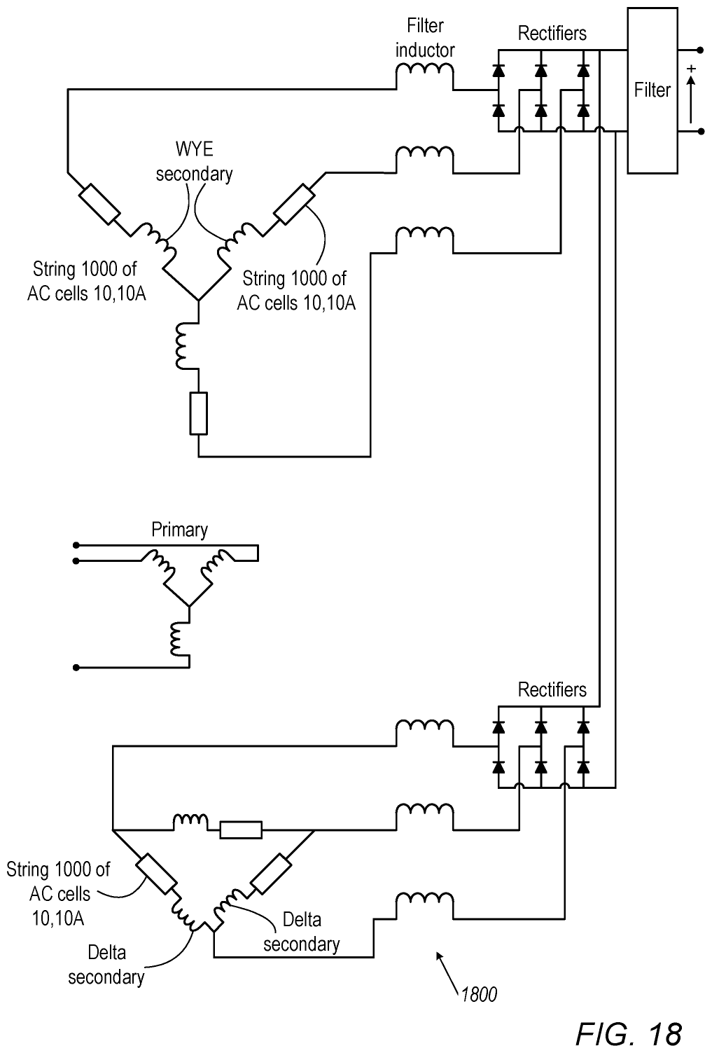

Reference is now also made to FIG. 18 which illustrates an AC: DC system 1800 which illustrates a three phase hybrid power transformer having two type of secondaries, according to features of the present invention. Specifically, AC:DC system 18 illustrates use of a Wye secondary and a delta secondary. Controlled AC strings 1000 and respective power inductors are connected in series with each secondary of the power transformer. Such a configuration may exhibit higher frequency of ripple after rectification.

The terms “mains”, “grid”, “power grid” and “electrical power grid” are used herein interchangeably.

The term “power line” as used herein refers to an electrical conductor or cable configured for carrying alternating current (AC). In context of regulation of the power grid or mains voltage, the term “power line” may refer to a power line of the power grid, e.g. 230 volts root-mean-square. In context of providing an AC voltage to a rectifier/filter circuit for battery charging, “power line” may conduct a previously specified AC voltage, e.g. 24 volts, typically less than grid voltage.

The term “transformer” as is an electrical device that transfers electrical energy between two or more circuits through electromagnetic induction to increase or decrease the alternating voltages in electric power applications. A varying current in the transformer's primary winding creates a varying magnetic flux in the transformer core and a varying field impinging on the transformer's secondary winding. Power transformers may include two main active parts: the core, which is made of high-permeability, grain-oriented, usually silicon electrical steel, layered in pieces; and windings, which are made of copper conductors wound around the core, providing electrical input and output. Two basic configurations of core and windings exist, the core form and the shell form. In the usual shell-type power transformer, both primary and secondary are on one leg and are surrounded by the core, whereas in a core-type power transformer, cylindrical windings cover the core legs.

The term “series connection” as used herein, in the context of two or more electrical components, is an electrical connection in which the current through each of the components is the same, and the voltage across the connection is the sum of the voltages across each component

The term “parallel connection” as used herein in the context of parallel electrical connection of two or more components, is an electrical connection in which the voltage across each of the components is the same, and the total current is the sum of the currents through each component.

The term “add” or “sum” as used herein refers to adding voltage between a series connected components is vectorial addition taking account the phases of the electrical power being added.

The transitional term “comprising” as used herein is synonymous with “including”, and is inclusive or open-ended and does not exclude additional, unrecited elements or method steps. The articles “a”, “an” is used herein, such as “a magnetic core” or “a sensor” have the meaning of “one or more” that is “one or more magnetic cores”, “one or more sensors”.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

Although selected features of the present invention have been shown and described, it is to be understood the present invention is not limited to the described features.

What is claimed is:

1. A device configured to regulate AC voltage, the device comprising:
a magnetic core;
a plurality of windings around the magnetic core;
a plurality of switch arrays connectable between an AC power source and the respective windings, the switch arrays including a respective plurality of switches, wherein the switches are controllable to connect the AC power source to the windings in a first polarity or in a second polarity, wherein the first polarity and second polarity are different polarities; and
an electrical conductor through the magnetic core, wherein the electrical conductor is series-connectable to a power line, wherein an AC voltage of the power line is regulated by adding an AC voltage of the electrical conductor responsive to selection of the switches of the switch arrays.

2. The device of claim 1, wherein at least one of the switch arrays is further controllable to:
(i) disconnect an AC power source from a respective winding,
(ii) disconnect an AC power source from the respective winding and short circuit the respective winding, or
(iii) add zero voltage to the electrical conductor.

3. The device of claim 1, wherein the magnetic core, the windings, and the electrical conductor comprise a transformer, wherein the windings include a plurality i of primary windings, wherein i is a plural integer, wherein the i^{th} winding includes Nᵢ turns, wherein Nᵢ are positive integers, wherein the electrical conductor is a secondary of one turn, wherein primary to secondary turns ratio of the transformer equals Nᵢ respectively for the primary windings.

4. The device of claim 3, wherein during operation a primary AC voltage VACᵢ is applied to the i primary windings, wherein the AC voltage of the electrical conductor is incremented by plus or minus primary AC voltage VACᵢ divided by the turns ratio Nᵢ, (±VACᵢ/Nᵢ) or zero depending on the selection of the switches of the switch arrays.

5. The device of claim 1, wherein the magnetic core includes a plurality of magnetic cores and wherein the electrical conductor is inserted through the magnetic cores.

6. The device of claim 1, wherein the electrical conductor is a single electrical conductor inserted through the magnetic core.

7. The device of claim 1, wherein the magnetic core includes a gap, wherein during operation peak magnetic flux through the core is lower than a saturation level of the magnetic core.

8. The device of claim 1, wherein during operation a primary AC voltage is applied to the windings, the device further comprising:
a controller;
a sensor connectable to the controller, the sensor configured to sense primary AC voltage VACᵢ and to switch between operational switching states of the switches, at a switching time t_{S} when primary AC voltage VACᵢ is within a previously determined time interval of a maximum positive or negative peak voltage.

9. The device of claim 8, wherein during operation a primary AC voltage is applied to the windings, the device further comprising:
a sensor connectable to the controller; wherein during switching the controller is configured to sense the primary AC voltage and AC input frequency, and to match a first attenuation peak of a digital finite input response filter to correspond with the AC input frequency.

10. The device of claim 1, wherein during operation a primary AC voltage is applied to the windings, the device further comprising:
a controller;
a magnetic flux sensor connectable to the controller;
an auxiliary winding around or through the core;
wherein the controller is configured to sense magnetic flux using the magnetic flux sensor and to drive the auxiliary winding with a compensation current having a level and polarity that reduces below a previously determined threshold a flux transient in the core.

11. The device of claim 1, wherein the power line is part of an AC power grid and the device is controllable to regulate grid voltage.

12. The device of claim 1, wherein the power line is configured to feed a direct current DC regulating circuit to provide a regulated DC voltage.

13. A method for regulating voltage in an alternating current (AC) system using a device including: a magnetic core, a plurality of windings around the core and a plurality of switch arrays connectable between an AC power source and the respective windings, the switch arrays including a respective plurality of switches and an electrical conductor disposed through the core, the method comprising:
series-connecting the electrical conductor to a power line;
during operation, controlling the switches thereby connecting the AC power source to the windings in a first polarity or in a second polarity, wherein the first polarity and second polarity are different polarities thereby regulating an AC voltage of the power line by adding an AC voltage of the electrical conductor responsive to said controlling of the switches.

14. The method of claim 13, during operation, controlling at least one of the switch arrays thereby
(i) disconnecting an AC power source from a respective winding,
(ii) disconnecting an AC power source from the respective winding and short circuit the respective winding, or
(iii) adding zero voltage to the electrical conductor.

15. The method of claim 13, further comprising:
during operation of the device, applying a primary AC voltage VACᵢ to the i primary windings, wherein the AC voltage of the electrical conductor is incremented by plus or minus primary AC voltage VACᵢ divided by the turns ratio Nᵢ, (±VACᵢ/Nᵢ) or zero depending on said controlling of the switches.

16. The method of claim 13, wherein the magnetic core includes a plurality of magnetic cores, the method further comprising:
inserting the electrical conductor through the magnetic cores.

17. The method of claim 13, further comprising:
during operation of the device, applying a primary AC voltage VAC to the windings;
sensing a primary AC voltage VACᵢ; and
switching between operational switching states of the switches, at a switching time t_{S} when primary AC voltage VACᵢ is within a previously determined time interval of a maximum positive or negative peak voltage.

18. The method of claim 13, further comprising:
during operation of the device, applying a primary AC voltage VAC to the windings;
switching between operational switching states of the switches;
during switching sensing the primary AC voltage and AC input frequency; and
matching a first attenuation peak of a digital finite input response filter (FIR) to correspond with the AC input frequency.

19. The method of claim 13, further comprising:
during operation of the device, applying a primary AC voltage VAC to the windings;
sensing magnetic flux and responsive to sensed magnetic flux, driving a compensation current, thereby reducing below a previously determined threshold a flux transient in the core.

20. The method of claim 13, further comprising:
controlling the device to regulate grid voltage; or
feeding a direct current (DC) regulating circuit thereby regulating DC voltage.
